(19) United States
(12) Patent Application Publication
(10) Pub. No.: US 2024/0345231 A1
(43) Pub. Date: Oct. 17, 2024

(54) OPTICAL DETECTION DEVICE FOR MONITORING A MONITORING REGION WITH CHECK ON FUNCTIONAL SAFETY

(71) Applicant: VALEO SCHALTER UND SENSOREN GMBH, Bietigheim-Bissingen (DE)

(72) Inventors: Jochen Schenk, Bietigheim-Bissingen (DE); Juergen Nies, Bietigheim-Bissingen (DE); Frank Selbmann, Bietigheim-Bissingen (DE); Johannes Appl, Bietigheim-Bissingen (DE); Heiko Hofmann, Bietigheim-Bissingen (DE)

(73) Assignee: VALEO SCHALTER UND SENSOREN GMBH, Bietigheim-Bissingen (DE)

(21) Appl. No.: 18/292,575

(22) PCT Filed: Jul. 20, 2022
(86) PCT No.: PCT/EP2022/070281

§ 371 Date: Jan. 26, 2024

(30) Foreign Application Priority Data
Jul. 26, 2021 (DE) 10 2021 119 239.0

(51) Int. Cl. G01S 7/497; G01S 7/481; G01S 7/4863; G01S 17/931

(52) U.S. Cl. CPC G01S 7/497; G01S 7/4817; G01S 7/4863; G01S 17/931

(57) ABSTRACT

A method for operating an optical detection device provided for monitoring at least one monitoring region is disclosed. The method includes actuating at least one light-emitting element to transmit a light signal, receiving at least one reflected light signal using at least two monitoring regions of at least one receiver, and using at least one received light signal to determine at least on receive variable. The eye safety of the detection device is checked by configuring at least one of the receiving regions as a measurement receiving region and at least one of the receiving regions as a test region, generating at least one measurement receive variable that characterizes a quantity of light captured in one measurement time interval, and generating at least one test receive variable that characterizes a quantity of light captured in one test time interval.

### TECHNICAL FIELD

The invention relates to a method for operating an optical detection device provided for monitoring at least monitoring region, in which
at least one light-emitting element is actuated to transmit at least one light signal,
at least one reflected light signal is received using at least two receiving regions of at least one receiver,
at least one received light signal is used to determine at least one receive variable,
wherein a functional safety of the detection device is checked at least intermittently.

The invention also relates to an optical detection device for monitoring at least one monitoring region,
having at least one light-emitting element for transmitting light signals,
having at least two receiving regions for receiving reflected light signals,
having at least one means for determining receive variables from received light signals,
having at least one means for controlling the optical detection device and for processing receive variables,
and having at least one means for checking a functional safety of the detection device.

In addition, the invention relates to a vehicle having at least one detection device for monitoring at least one monitoring region, the at least one detection device having
at least one light-emitting element for transmitting light signals,
at least two receiving regions for receiving reflected light signals,
at least one means for determining receive variables from received light signals,
at least one means for controlling the optical detection device and for processing receive variables,
and at least one means for checking a functional safety of the detection device.

### PRIOR ART

A method for calibrating an optical scanning system is known from DE 10 2017 223 618 A1. The method starts with the step in which the optical transmission unit transmits laser lines, which are transmitted into the rear region of the housing during the dark phase. In other words, the optical scanning system radiates to the rear or the rear region of the housing, which is impermeable to optical rays. In a subsequent step, the laser lines are diverted using the reflector unit arranged in the rear region of the housing. This means that the reflector unit diverts the laser lines in such a way that laser lines are received or captured by the optical receiving unit immediately, i.e. without interacting with objects from the surroundings outside of the housing. In a subsequent step the laser lines diverted or deflected by the reflector unit are received by the receiving unit. In a subsequent step an orientation of the laser lines is determined, and in a subsequent step a detector unit of the optical receiving unit is calibrated on the basis of the orientation of the laser lines. As an alternative to the step in which the detector unit is calibrated, or in addition, one step can comprise determining the laser power on the basis of the diverted laser line. Optionally, separate steps following the step in which an orientation of the laser lines is determined can comprise determining an eye safety on the basis of the diverted laser line and monitoring individual laser diodes on the basis of the diverted laser line, or the functional safety of the optical scanning system.

The invention is based on the object of designing a method, a detection device and a vehicle of the type mentioned above in which the functional safety of the detection device is improved.

### DISCLOSURE OF THE INVENTION

The invention achieves this object for the method in that a duration of the transmission of each of the light signals is limited to a specified transmission time interval in order to achieve eye safety for the detection device,
the eye safety of the detection device is checked by
configuring at least one of the receiving regions as a measurement receiving region and at least one of the receiving regions as a test receiving region,
generating at least one measurement receive variable that characterizes a quantity of light captured using at least one measurement receiving region in at least one measurement time interval,
generating at least one test receive variable that characterizes a quantity of light captured using at least one test receive region in at least one test time interval,
the at least one test time interval being longer than the at least one measurement time interval and the at least one test time interval being longer than the transmission time interval,
if at least one test receive variable characterizes a quantity of light that is greater, outside of a specified tolerance variable, than the quantity of light that is characterized using the at least one measurement receive variable, a fault state is generated.

According to the invention, eye safety is achieved for the detection device by limiting the transmission of light signals. For this purpose, the duration of the transmission of a light signal is limited to a specified transmission time interval in each case. For a light signal transmitted for the duration of the transmission time interval, the longer the transmission time interval, the greater the quantity of light transmitted. By limiting the transmitted quantity of light to the transmission time interval, eye safety is achieved for the detection device. The transmission time interval is specified in such a way, in particular on the basis of the type of light signals transmitted, that eye safety is reliably achieved.

The eye safety of the detection device within the meaning of the invention is a function and/or property of the detection device that ensures that in particular legally stipulated eye safety limits are observed when operating the detection device. Eye safety is a functional safety of the detection device.

Advantageously, limiting the duration of the transmission of a light signal using at least one safety means can be carried out in particular by way of software and/or hardware.

Advantageously, the at least one transmission time interval can be specified such that the transmission of the light signals is significantly below the eye safety limit. This will ensure that the eye safety limit is safely observed.

The receiving regions of the at least one receiver are used to receive reflected light signals, which can be referred to as echo signals, and to convert them into receive variables. Advantageously, the receiving regions can be used to receive light signals, in particular reflected by objects, from at least one monitoring region. The receive variables can be used to determine information about the monitoring region, in particular object information, such as distance, speed and/or direction of objects relative to the detection device.

Furthermore, at least one receive variable can be taken as a basis for checking eye safety for the detection device. This can involve using receive variables that originate from echo signals coming from the at least one monitoring region. Alternatively or in addition, receive variables from light signals reflected inside the detection device can be used.

A malfunction in particular of at least one safety means can lead to a light signal still being transmitted after the end of the transmission time interval. This can lead to an impairment of eye safety.

To check the eye safety of the detection device, in particular the function of the at least one safety means, the reflected light signals are received using at least two receiving regions, namely at least one measurement receiving region and at least one test receiving region, and are converted into respective receive variables. The reflected light signals are captured using the at least one measurement receiving region for the duration of at least one measurement time interval. At least one test receiving region is used to capture the light signals for the duration of at least one test time interval.

The at least one test time interval is longer than the transmission time interval. In this way, the at least one test receiving region can be used to capture light signals that are transmitted beyond the end of the at least one measurement time interval using the at least one light-emitting element.

The at least one test time interval is longer than the at least one measurement time interval and the transmission time interval. In this way, the at least one test receiving region can be used to receive and convert light signals for a longer period of time than with the at least one measurement receiving region.

In this way, the at least one measurement receiving region and the at least one measurement time interval can be used to characterize a target state with respect to light emission on the assumption that eye safety is functioning, in particular the safety means is functioning. The at least one test receiving region and the at least one test time interval can be used to characterize an actual state with respect to light emission for eye safety, in particular for the at least one safety means.

If the quantity of light that is characterized using at least one test receive variable is greater, outside of a specified tolerance limit, than the quantity of light that is characterized using at least one measurement receive variable, i.e. the actual state with respect to light emission deviates from the target state outside of a tolerance limit, it is concluded that the at least one test receiving region has continued to capture echo signals that originate from light signals transmitted using the at least one light-emitting element in the period of time between the end of the at least one measurement time interval and the end of the at least one test time interval. From this, it is concluded that the limitation of the transmission of light signals is faulty. A fault state is then generated in order not to endanger the eye safety of the detection device.

The tolerance limit for the comparison of the test receive variables and the measurement receive variables can advantageously be specified, in particular at the end of a production line. The tolerance limit can advantageously also be zero.

The measurement receiving regions and the test receiving regions can advantageously be receiving regions of the same type. To check eye safety, in particular the function of the at least one safety means, some of the receiving regions can be configured as measurement receiving regions and other instances of the receiving regions can be configured as test receiving regions.

Advantageously, the at least one light-emitting element can be used to transmit light signals in the form of in particular pulsed laser signals. Laser signals can be produced simply and precisely.

Advantageously, the detection device can operate according to a signal time-of-flight method, in particular a signal pulse time-of-flight method. Detection devices operating according to the signal pulse time-of-flight method can be designed and referred to as time-of-flight (TOF) systems, light detection and ranging (LiDAR) systems, laser detection and ranging (LaDAR) systems or the like.

Advantageously, the detection device can be designed as a scanning system. In this context, a monitoring region can be sampled, that is to say scanned, using light signals. For this purpose, the directions of propagation of the light signals can be modified, in particular swivelled, over the monitoring region. This can involve using at least one signal deflection device, in particular a scanning device, a deflection mirror device or the like. The detection device can alternatively be designed as a so-called flash system, in particular as flash LiDAR. Appropriately spread light signals can simultaneously irradiate a relatively large part of the monitoring region or the entire monitoring region.

Advantageously, the detection device can be designed as a laser-based distance measurement system. Laser-based distance measurement systems can include lasers, in particular diode lasers, as signal sources. Lasers can be used to transmit in particular pulsed laser signals. Lasers can be used to emit light signals in wavelength ranges that are visible or not visible to the human eye. Accordingly, receivers of the detection device can have or consist of sensors, in particular point sensors, line sensors and/or area sensors, in particular (avalanche) photodiodes, photodiode lines, CCD sensors, active pixel sensors, in particular CMOS sensors or the like, that are designed for the wavelength of the transmitted light signals. Laser-based distance measurement systems can advantageously be designed as laser scanners. Laser scanners can be used to scan monitoring regions with in particular pulsed laser signals, in particular laser beams.

The invention can advantageously be used in vehicles, in particular motor vehicles. The invention can advantageously be used in land vehicles, in particular passenger vehicles, trucks, buses, motorcycles or the like, aircraft, in particular drones, and/or watercraft. The invention can also be used in vehicles that can be operated autonomously or at least semiautonomously. However, the invention is not restricted to vehicles. It can also be used in stationary operation, in robotics and/or in machines, in particular construction or transport machinery, such as cranes, excavators or the like.

The detection device can advantageously be connected to or can be part of at least one electronic control device of a vehicle or of a machine, in particular a driver assistance system and/or a chassis control system and/or a driver information device and/or a parking assistance system and/or a gesture recognition system or the like. In this way, at least some of the functions of the vehicle or of the machine can be performed autonomously or semiautonomously.

The detection device can be used for detecting stationary or moving objects, in particular vehicles, persons, animals, plants, obstacles, roadway irregularities, in particular potholes or rocks, roadway boundaries, traffic signs, open spaces, in particular parking spaces, precipitation or the like, and/or movements and/or gestures.

In one advantageous configuration of the method, at least one measurement time interval and/or at least one test time interval and/or a transmission time interval can be realized so as to at least partially overlap in time and/or at least one measurement time interval and/or at least one test time interval and/or a transmission time interval can be started simultaneously. In this way, the at least one measurement receiving region and the at least one test receiving region can be used to receive the same light signal at least intermittently. This allows the respective determined receive variables to be compared with one another more effectively. In addition, the measurement receive variables and the test receive variables can be determined simultaneously in a time-saving manner.

Simultaneously starting the time intervals allows gaps to be avoided. This allows the measurement receive variables and the test receive variables to be compared with one another more effectively.

Alternatively or additionally, at least one measurement time interval and at least one test time interval can be started in nonoverlapping succession. In this way, the determination of the measurement receive variables and the determination of the test receive variables can be performed in succession.

In a further advantageous configuration of the method, at least one test receive variable and at least one measurement receive variable of spatially adjacent receiving regions can be determined and/or respective measurement receive variables of at least two spatially adjacent measurement receiving regions can be determined and/or respective test receive variables of at least two spatially adjacent test receiving regions can be determined. In this way, the receiving regions involved can be used to receive the same light signal. This allows a comparability of the determined receive variables to be improved further.

Advantageously, respective measurement receive variables of at least two spatially adjacent measurement receiving regions can be determined. As an alternative or in addition, respective test receive variables of at least two spatially adjacent test receiving regions can be determined. In this way, a spatial resolution can additionally be attained when capturing the light signals. This allows in particular directions from which light signals come to be determined. Advantageously, multiple measurement receiving regions and/or multiple test receiving regions can be arranged in matrix form and/or in rows.

In a further advantageous configuration of the method,
the at least one measurement time interval can be specified as having approximately the same length as the transmission time interval
and/or the at least one measurement time interval can be specified as not having a greater length than at least one transmission time interval. In this way, a target state with respect to light emission can be characterized more precisely using the at least one measurement receiving region on the assumption that eye safety is functioning, in particular the at least one safety means is functioning.

Advantageously, the at least one measurement time interval can be specified as not having a greater length than at least one transmission time interval. In this way, the at least one measurement receiving region can be used during the at least one measurement time interval to capture at most the quantity of light that is transmitted during the transmission time interval using the at least one light-emitting element when eye safety is functioning, in particular when the safety means is functioning.

In a further advantageous configuration of the method,
at least one check on eye safety is carried out during regular operation of the detection device
and/or at least one check on eye safety is carried out outside of regular operation of the detection device.

When checking eye safety during regular operation, the safety shutdown can be checked more frequently.

When checking eye safety outside of regular operation, all receiving regions can be used as measurement receiving regions instead during regular operation.

Advantageously, the check on eye safety can be carried out after the detection device has been switched on. In this way, malfunctions can be detected before regular operation begins.

In a further advantageous configuration of the method, at least one light-emitting element can be used to transmit modulated light signals. In this way, information about the at least one monitoring region, in particular distances, speeds and/or directions of detected objects in the monitoring region, can be determined more effectively, in particular more easily and/or more accurately.

Advantageously, modulated light signals can be transmitted in the form of light pulses. In this way, the detection device can be operated in particular according to a time-of-flight method. Alternatively or in addition, modulated light signals can be transmitted as continuous wave signals.

Advantageously, the at least one light-electric element can be actuated by means of in particular electrical trigger signals to transmit light signals. Trigger signals can be generated using appropriate means of the detection device, in particular a control and/or driver device.

In a further advantageous configuration of the method, the fault state generated can be a shutdown of at least the at least one light-electric element, at least one error signal, at least one visual, audible and/or haptic output signal or the like.

Shutting down at least the at least one light-electric element allows the further transmission of light signals to be ensured.

Error signals can be used to output information about the faulty condition of the detection device, in particular the eye safety of the detection device. Error signals can be processed in particular automatically.

Visual, audible and/or haptic output signals can be used to inform users of the detection device and/or maintenance personnel for the detection device about the presence of a fault directly.

Furthermore, the invention achieves the object for the detection device in that the detection device has at least one safety means for limiting the duration of the transmission of light signals to a specified transmission time interval in order to achieve eye safety and at least one checking device for the at least one safety means,
the checking device having
means for configuring at least one receiving region as a measurement receiving region for the purpose of generating from at least one received light signal at least one measurement receive variable that characterizes a quantity of light that can be captured using at least one measurement receiving region in at least one measurement time interval, means for configuring at least one receiving region as a test receiving region for the purpose of generating from at least one received light signal at least one test receive variable that characterizes a quantity of light that can be captured using at least one test receiving region in at least one test time interval,
means for evaluating at least some of the receive variables and means for generating at least one fault state if at least one test receive variable characterizes a quantity of light that is greater, outside of a tolerance variable, than the quantity of light that is characterized using at least one measurement receive variable.

According to the invention, the detection device has at least one checking device for checking the at least one safety means for limiting the transmission of light signals. The checking device can be used to check whether the at least one safety means is functioning correctly. The function of the at least one safety means is to limit the duration of the transmission of the light signals. In this way, the at least one safety means can be used to achieve eye safety. The at least one checking device can thus be used to check the eye safety of the detection device.

The at least one checking device can be used to determine if the at least one safety means does not shut down the transmission of a light signal after a specified transmission time interval due to a malfunction. In this case, means of the checking device can be used to generate a fault state. The fault state can include appropriate measures. In particular,
the at least one light-emitting element can be shut down. Alternatively or additionally, at least one error signal and/or at least one visual, audible and/or haptic output signal can be generated.

In one advantageous embodiment,
at least one measurement receiving region and at least one test receiving region may be formed from receiving regions of the same type
and/or at least one measurement receiving region and/or at least one test receiving region may be configurable separately to record receive variables in different time intervals.

At least one measurement receiving region and/or at least one test receiving region may be formed from receiving regions of the same type. In this way, receiving regions of the at least one receiver can be configured either as measurement receiving regions or as test receiving regions.

Alternatively or in addition, at least one measurement receiving region and/or at least one test receiving region may be actuatable separately to record receive variables in different time intervals. In this way, the measurement receiving regions and the test receiving regions can be activated for different time intervals.

In a further advantageous embodiment,
at least one receiver can have multiple point sensors, at least one line sensor and/or at least one area sensor, which are used to produce respective receiving regions.

A point sensor is used to implement a specific receiving region. The use of multiple point sensors allows multiple receiving regions to be produced. A point sensor may be in particular a photodiode or the like.

In the case of a line sensor, multiple receiving regions are arranged in a row. Line sensors can be produced more compactly and/or read more easily than single point sensors arranged next to one another. A line sensor can advantageously be realized as a diode linear array or a row of an area sensor, in particular a CCD sensor, an active pixel sensor or the like.

In the case of an area sensor, a plurality of receiving regions are arranged in two dimensions, in particular in the form of a matrix. An area sensor can advantageously be realized as a CCD sensor, an active pixel sensor or the like.

In addition, line sensors and area sensors can also be used for spatially resolved measurements.

Furthermore, the invention achieves the object for the vehicle in that
the detection device has at least one safety means for limiting the duration of the transmission of light signals to a specified transmission time interval in order to achieve eye safety and at least one checking device for the at least one safety means,
the checking device having
means for configuring at least one receiving region as a measurement receiving region for the purpose of generating from at least one received light signal at least one measurement receive variable that characterizes a quantity of light that can be captured using at least one measurement receiving region in at least one measurement time interval, means for configuring at least one receiving region as a test receiving region for the purpose of generating from at least one received light signal at least one test receive variable that characterizes a quantity of light that can be captured using at least one test receiving region in at least one test time interval,
means for evaluating at least some of the receive variables and
means for generating at least one fault state if at least one test receive variable characterizes a quantity of light that is greater, outside of a tolerance variable, than the quantity of light that is characterized using at least one measurement receive variable.

According to the invention, the vehicle has at least one detection device that observes eye safety limits. The at least one detection device can be used to monitor at least one monitoring region outside the vehicle and/or inside the vehicle, in particular for objects.

In an advantageous embodiment, the vehicle can have at least one driver assistance system. A driver assistance system can be used to operate the vehicle autonomously or semiautonomously.

Advantageously, at least one detection device can be functionally connected to at least one driver assistance system. In this way, information about a monitoring region, in particular object information determined using the at least one detection device, can be used with the at least one driver assistance system for controlling autonomous or semiautonomous operation of the vehicle.

Moreover, the features and advantages indicated in connection with the method according to the invention, the detection device according to the invention and the vehicle according to the invention, and the respective advantageous configurations thereof, apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider individually the features that have been disclosed in combination in the drawing, the description and the claims and will combine them to form meaningful further combinations. In the schematic figures,

FIG. 1 shows a front view of a vehicle having a driver assistance system and a LiDAR system for detecting objects in the direction of travel in front of the vehicle;

FIG. 2 shows a functional illustration of the vehicle having the driver assistance system and the LiDAR system from FIG. 1;

FIG. 3 shows a plan view of a detail from a receiver of the LiDAR system from FIGS. 1 and 2 with a plurality of receiving regions arranged in two dimensions;

FIG. 4 shows, from top to bottom, the time characteristics of a trigger input signal for a trigger output signal for controlling a laser of the LiDAR system from FIGS. 1 and 2, the trigger output signal, a measurement integration signal for actuating measurement receiving regions of the receiver from FIG. 3 and a test integration signal for actuating test receiving regions of the receiver, safety means of the LiDAR system being used to terminate the transmission of laser signals using the laser after a transmission time interval;

FIG. 5 shows an intensity/receiving region graph for receive variables, which are generated from the laser echo signals integrated over the integration time of the respective receiving regions, along a column containing receiving regions of the receiver from FIG. 3, wherein the receiving regions are alternately actuated as measurement receiving regions and as test receiving regions using the respective integration signals and the safety means of the LiDAR system are used to terminate the transmission of a laser signal using the laser after the transmission time interval;

FIG. 6 shows, from top to bottom, the time characteristics analogously to FIG. 4, wherein the transmission of the transmission signal using the laser is not terminated after the transmission time interval;

FIG. 7 shows an intensity/receiving region graph for receive variables analogously to FIG. 5, wherein the transmission of a transmission signal using the laser is not terminated after the transmission time interval.

In the figures, identical elements are provided with identical reference signs.

### EMBODIMENT(S) OF THE INVENTION

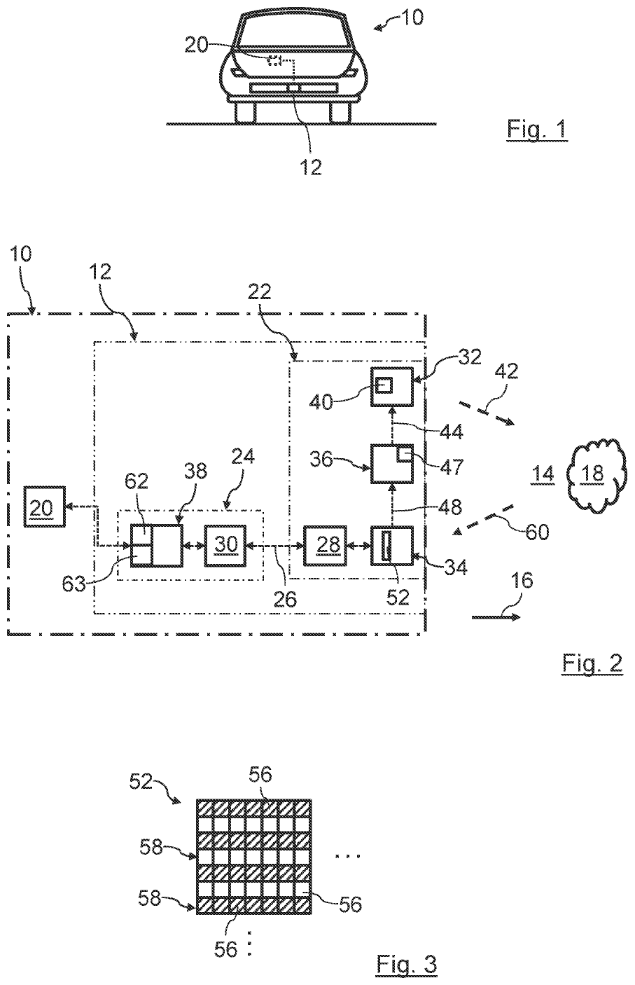

FIG. 1 shows the front view of a vehicle 10, for example in the form of a passenger vehicle.

The vehicle 10 has an optical detection device, for example in the form of a LIDAR system 12. The LiDAR system 12 is designed as a laser scanner. For example, the LiDAR system 12 can be a near-field laser scanner (NFL). FIG. 2 shows a functional illustration of the vehicle 10 having the LiDAR system 12.

By way of example, the LiDAR system 12 is arranged in the front fender of the vehicle 10. The LiDAR system 12 can be used to monitor a monitoring region 14 in the direction of travel 16 in front of the vehicle 10 for objects 18. The LiDAR system 12 can also be arranged at another point on the vehicle 10 and oriented differently. The LiDAR system 12 can also be arranged in the vehicle 10 to monitor an interior. The LiDAR system 12 can be used to determine object information, for example distances, directions, and speeds of objects 18 relative to the vehicle 10, or to the LiDAR system 12, respectively, or corresponding characterizing variables.

The objects 18 can be stationary or moving objects, for example other vehicles, persons, animals, plants, obstacles, roadway irregularities, for example potholes or rocks, roadway boundaries, traffic signs, open spaces, for example parking spaces, precipitation or the like. Gestures of persons can also be detected using the LiDAR system 12.

The LiDAR system 12 is connected to a driver assistance system 20 of the vehicle 10. The driver assistance system 20 can be used to operate the vehicle 10 autonomously or semiautonomously.

The LiDAR system 12 comprises, for example, a sensor unit 22, for example in the form of an NFL sensor, and a control unit 24. The sensor unit 22 is connected to the control unit 24 via an interface 26, for example a low-voltage differential signaling (LVDS) interface, for example an FPD-Link III. To produce the interface 26, the sensor unit 22 has a serializer 28 and the control unit 24 has a deserializer 30.

The sensor unit 22 comprises a transmitting device 32, a receiving device 34, a driver and safety device 36 and the serializer 28.

The control unit 24 comprises a control and evaluation device 38 and the deserializer 30.

The interface 26 can be used to transfer data from the receiving device 34 to the control and evaluation device 38. Furthermore, the interface 26 has a return channel. The return channel can be used by the control and evaluation device 38 to communicate with the receiving device 34, for example using an I2C protocol.

The transmitting device 32 has, for example, a laser 40, for example a diode laser, as a signal source. The laser 40 can be used to transmit for example pulsed laser signals 42. The transmitting device 32 may optionally have at least one optical system, for example at least one optical lens, which can be used to influence, for example spread and/or focus, the generated laser signals 42 as appropriate. The LiDAR system 12 can be designed as a scanning LiDAR system or as a flash LiDAR system.

In addition, the transmitting device 32 may optionally have a signal deflection device that can be used to direct the laser signals 42 into the monitoring region 14. The signal deflection device can be modifiable, for example swivelable. In this way, the directions of propagation of the laser signals 42 can be swiveled and the monitoring region 14 can be sampled or scanned.

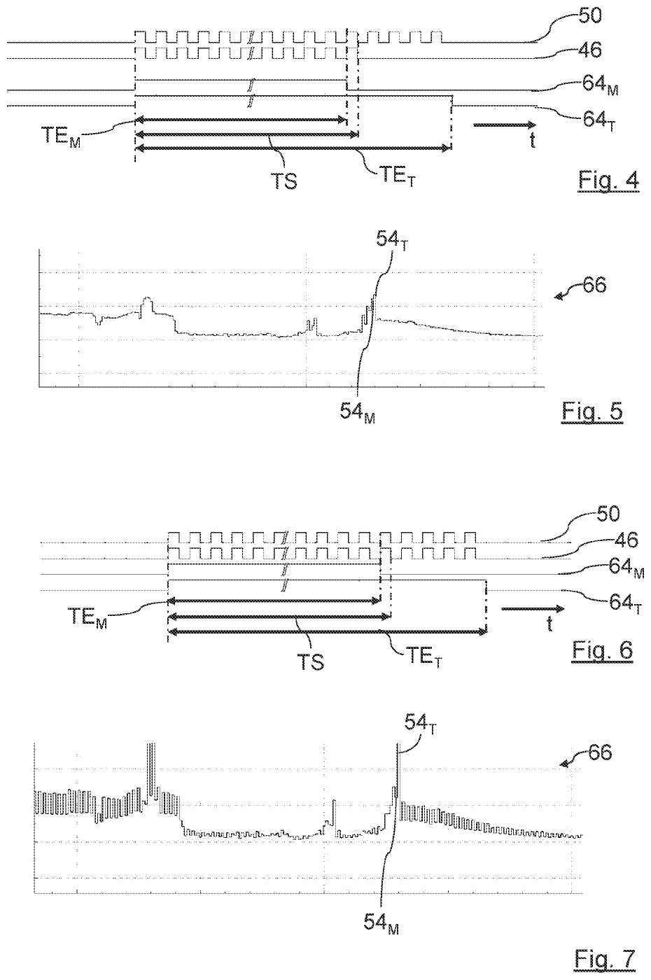

The transmitting device 32 is connected to the driver and safety device 36 via a control connection 44. The control connection 44 can be used to actuate the laser 40 with trigger output signals 46 from the driver and safety device 36 to transmit the laser signals 42. FIG. 4 shows an example of a detail from a trigger output signal 46 over the course of time.

The driver and safety device 36 is connected to the receiving device 34 via a signal connection 48. The signal connection 48 can be used to transmit trigger input signals 50 from the receiving device 34 to the driver and safety device 36. FIG. 4 shows an example of a detail from a trigger input signal 50 over the course of time.

The driver and safety device 36 has a breakable connection between the signal connection 48 and the control connection 44 that can be used to transfer the trigger input signals 50 from the signal connection 48 to the control connection 44 and to transmit them to the transmitting device 32 as trigger output signals 46.

The driver and safety device 36 has a safety means 47 that can be used to interrupt the connection between the signal connection 48 and the control connection 44. The safety means 47 can be used to limit for example the transmission of laser signals 42 to a specified transmission time interval TS. The transmission time interval TS is specified such that the transmitted light signals 42 are below an eye safety limit. Eye safety can thus be achieved when operating the LiDAR system 12.

The receiving device 34 has a receiver 52 and electronic components for controlling the receiver 52 and for generating receive variables 54. The receiver 52 and the electronic components can, for example, be realized as an image sensor, a so-called imager, as a “system on chip”. In addition, the receiving device 34 has signal generating means that can be used to generate the trigger input signals 50.

The receiver 52 is realized for example as an area sensor in the form of a CCD array. Alternatively, there may also be provision for an active pixel sensor, multiple photodiode linear arrays or the like. A detail from the receiver 52 is shown in FIG. 3 in a plan view. The receiver 52 has a plurality of receiving regions 56 arranged next to one another in multiple rows 58. The receiving regions 56 can also be referred to as “pixels”.

The receiving regions 56 can be used to convert light signals, for example echo signals 60 from, for example, laser signals 42 reflected by an object 18 in the monitoring region 14, into corresponding electrical received signals. The received signals can be used to generate the receive variables 54. The receive variables 54 can be used to characterize the received echo signals 60, for example the quantity of light or light energy thereof.

The receiving regions 56 can be activated for different time intervals TE, in which respective receive variables 54 can be generated from arriving echo signals 60. The time intervals TE can also be referred to as “integration times”. By way of example, receiving regions 56 that are located in the same row 58 can be activated in the same time interval TE.

The receiving device 34 may optionally have, on its optical input side, an echo signal deflection device and/or an optical system, for example an optical lens, which are able to be used to direct the echo signals 60 to the receiver 52.

The receiving device 34 is connected to the control and evaluation device 38 by means of the interface 26 containing the serializer 28 and the deserializer 30.

The control and evaluation device 38 can be used to process the receive variables 54 generated using the receiving device 34. For example, the control and evaluation device 38 can be used to take the receive variables 54 and determine object variables therefrom, for example distance variables, direction variables and/or speed variables, which characterize distances, directions and/or speeds of detected objects 18 relative to the LiDAR system 12 or relative to the vehicle 10.

Furthermore, the control and evaluation device 38 can be used to configure the receiver 52, for example using the I²C protocol. For example, the receiving regions 56 can be activated with appropriate integration signals 64 for the respective time intervals TE. The integration signals 64 can, for example, be square-wave pulses having the length of the applicable time interval TE. The rising edge of the square-wave pulse of an integration signal 64 can be used to start the respective time interval TE and to activate the applicable receiving regions 56 to capture echo signals 60 for the duration of the square-wave pulse.

Furthermore, the control and evaluation device 38 can be used to configure the driver and safety device 36. For example, the length of the transmission time interval TS in which the laser 40 is used to transmit a laser signal 42 can be specified. In addition, the control and evaluation device 38 can be used to start the transmission time interval TS. The transmission time interval TS and the time intervals TE of the receiving regions 56 can be started in coordinated fashion, for example simultaneously.

Furthermore, the control and evaluation device 38 has a safety shutdown test means 62. The safety shutdown test means 62 can be used to test the function of the safety means 47 of the driver and safety device 36 and, if a malfunction is detected, to prevent further transmission of the laser signal 42.

For this purpose, the safety shutdown test means 62 can be used to check the function of the safety means 47 by actuating some of the receiving regions 56 as test receiving regions 56T by means of test integration signals 64T for activation during the test time intervals TET. Other instances of the receiving regions 56 can be actuated as measurement receiving regions 56_{T} by means of measurement integration signals 64M for activation during the measurement time intervals TE_{M}.

The measurement time intervals TE_{M} are, for example, slightly shorter than the transmission time interval TS. The test time intervals are longer than the measurement time intervals TE_{M} and longer than the transmission time interval TS. The test time intervals TE_{T} are specified such that the LiDAR system 12 is operated below the eye safety limit.

In addition, the safety shutdown test means 62 can be used to compare the test receive variables 54_{T} determined during the check by means of the test receiving regions 56_{T} with the measurement receive variables 54_{M} determined by means of the measurement receiving regions 56_{M}. If the test receive variables 54_{T} characterize a quantity of light of the received echo signal 60 that is greater than the quantity of light of the received echo signal 60 that is characterized using the measurement receive variables 54_{M}, a fault state control means 63 of the safety shutdown test means 62 can be used to generate a fault state. For example, the fault state control means 63 can be used to interrupt the connection between the signal connection 48 and the control connection 44 of the driver and safety device 36 as a fault state.

The functions and components of the control and evaluation device 38 and the driver and safety device 36 may be implemented centrally or locally. Some of the functions and components of the control and evaluation device 38 and the driver and safety device 36 may also be integrated in the transmitting device 32 and/or the receiving device 34. The control and evaluation device 38, the driver and safety device 36 and the driver assistance system 20 may also be partially combined. The functions of the control and evaluation device 38 and the driver and safety device 36 are implemented by way of software and hardware.

A method for operating the LiDAR System 12 is explained in more detail below. First regular operation for monitoring the monitoring region 14 and then a test mode for checking the safety means 47 of the driver and safety device 36 are described.

During regular operation, the control and evaluation device 38 is used to configure the receiving device 34 and to start the measurement. All receiving regions 56 are configured as measurement receiving regions 56_{M} and actuated with the same measurement integration signal 64M specified by the control and evaluation device 38. The measurement receiving regions 56_{M} are activated for the same measurement time interval TE_{M} to receive echo signals 60.

The receiving device 34 transmits a trigger input signal 50 to the driver and safety device 36 for the duration of the measurement time interval TE_{M}. The driver and safety device 36 transmits the trigger input signal 50 to the transmitting device 32 via the control connection 44 as trigger output signal 46. In response to the trigger output signal 46, the laser 40 is used to transmit a pulsed laser signal 42 into the monitoring region 14 for the duration of the measurement time interval TE_{M}.

When the measurement integration signal 64_{M} begins, the driver and safety device 36 is moreover used to start the specified transmission time interval TS. After the transmission time interval TS has elapsed, the safety means 47 is used to interrupt the connection between the signal connection 48 and the control connection 44, with the result that no further trigger output signal 46 is transmitted to the transmitting device 32. The transmission of the laser signal 42 is thus terminated. This prevents an eye safety limit from being exceeded in the event of a malfunction, for example when transmitting the measurement integration signal 64_{M}.

The transmitted laser signal 42 is reflected in the direction of the LiDAR system 12, for example by the object 18 in the monitoring region 14. During the measurement time interval TE_{M}, the reflected laser signal 42 is received as echo signal 60 using the measurement receiving regions 56 and the respective receive variables 54_{M} are generated.

The receive variables 54_{M} are transmitted to the control and evaluation device 38. The control and evaluation device 38 is used to determine an amplitude image 66 that characterizes the intensity characteristic of the echo signal 60 along the receiving regions 56_{M} of the receiver 52. FIG. 5 shows the section of an amplitude image 66 along a column perpendicular to the rows 58 of the receiver 52 as an example.

Furthermore, the control and evaluation device 38 is used to take the receive variables 54_{M} and determine object variables therefrom, for example distance variables, direction variables and/or speed variables, which characterize distances, directions and/or speeds of the detected object 18 relative to the LiDAR system 12, or relative to respective receiving regions 56_{M}.

The determined object variables are transmitted to the driver assistance system 20. The driver assistance system 20 is used to use the object variables to operate the vehicle 10 autonomously or semiautonomously.

In the test mode for checking the safety means 47 using the safety shut-off test means 62, the control and evaluation device 38 is used to configure the receiving device 34 as appropriate and to start the measurement. Some of the receiving regions 56 are configured as measurement receiving regions 56_{M} and some of the receiving regions 56 are configured as test receiving regions 56_{T}. For example, the rows 58 containing the receiving regions 56 are alternately configured as measurement receiving regions 56_{M} and as test receiving regions 56_{T}. The measurement receiving regions 56_{M} are actuated with the same measurement integration signal 64_{M} specified by the control and evaluation device 38. The measurement receiving regions 56_{M} are activated for the same measurement time interval TE_{M} to receive echo signals 60. The test receiving regions 56_{T} are actuated with the same test integration signal 64T specified by the control and evaluation device 38. The test receiving regions 56_{T} are ready to receive echo signals 60 for the same test time interval TE_{T}. The measurement time interval TE_{M} starts at the same time as the test time interval TE_{T}.

The receiving device 34 transmits the trigger input signal 50 to the driver and safety device 36 for the duration of the measurement time interval TE_{M}. The driver and safety device 36 transfers the trigger input signal 50 to the transmitting device 32 as trigger output signal 46. In response to the trigger output signal 46, the laser 40 is used to transmit the pulsed laser signal 42 into the monitoring region 14 for the duration of the measurement time interval TE_{M}.

When the measurement integration signal 64_{M} begins, the driver and safety device 36 is moreover used to start the specified transmission time interval TS.

If the driver and safety device 36 is functioning correctly, the connection between the signal connection 48 and the control connection 44 is interrupted after the transmission time interval TS has elapsed, analogously to regular operation, with the result that the trigger output signal 46 is no longer transmitted to the transmitting device 32. The transmission of the laser signal 42 is thus terminated. The signal characteristics for this situation are shown in FIG. 4.

The illuminated measurement receiving regions 56_{M} are used to receive the laser signal 42 reflected in the direction of the LiDAR system 12 by the object 18 in the monitoring region 14 as echo signal 60 during the measurement time interval TE_{M}, and respective measurement receive variables 54_{M} are generated. In addition, the echo signal 60 is received using the illuminated test receiving regions 56_{T} during the test time interval TE_{T}, and respective test receive variables 54_{T} are generated.

The measurement receive variables 54_{M} and the test receive variables 54_{T} are transmitted to the control and evaluation device 38. The control and evaluation device 38 is used to determine an amplitude image 66 that characterizes the intensity characteristic of the echo signal 60 along the measurement receiving regions 56_{M} and the test receiving regions 56_{T} of the receiver 52. FIG. 5 shows the section of the amplitude image 66 along a column perpendicular to the rows 58 of the receiver 52 as an example, the driver and safety device 36 functioning correctly there.

As shown in FIG. 4, the transmission time interval TS is slightly longer than the measurement time interval TE_{M}. The trigger output signal 46 is thus used after the end of the measurement time interval TE_{M} to activate the laser 40 for example for a further period of the trigger output signal 46 to transmit the laser signal 42. The accordingly latter portion of the associated echo signal 60 is no longer received using the measurement receiving regions 56_{M}, as these are not active outside of the measurement time interval TE_{M}. However, the latter portion of the echo signal 60 is received using the test receiving regions 56_{T} within the test time interval TE_{T}. As a result, the test receiving regions 56_{T} are exposed to the echo signal 60 of the laser signal 42 for slightly longer than the measurement receiving regions 56_{M}. The measurement receive variables 54_{M} that characterize the quantity of light received using the applicable measurement receiving regions 56_{M} are therefore, as shown in FIG. 5, slightly smaller than the respective test receive variables 54_{T} received using the respective adjacent test receiving regions 56_{T}. The intensity differences between the measurement receive variables 54_{M} and the test receive variables 54_{T} of the adjacent measurement receiving regions 56_{M} and test receiving regions 56_{T} are within a, for example specified, tolerance limit. The adjacent test receive variables 54_{T} and measurement receive variables 54 are compared with each other. Since the intensity differences are within the tolerance limit, a fault state is not generated using the safety shutdown test means 62.

If the driver and safety device 36, or the safety means 47, is not functioning correctly, it can happen that the connection between the signal connection 48 and the control connection 44 is not interrupted after the transmission time interval TS has elapsed. The trigger output signal 46 is thus still transmitted to the transmitting device 32. Transmission of the light signal 42 is continued even after the transmission time interval TS has elapsed. The signal characteristics for this situation are shown in FIG. 6. If the light signal 42 is transmitted for a relatively long time, eye safety is endangered.

As in the case of trouble-free operation, the laser signal 42 reflected in the direction of the LiDAR system 12 by the object 18 in the monitoring region 14 is received as echo signal 60 using the respective measurement receiving regions 56_{M} during the measurement time interval TE_{M}, and corresponding measurement receive variables 54_{M} are generated. In addition, the echo signal 60 is received using the respective test receiving regions 56_{T} during the test time interval TE_{T}, and corresponding test receive variables 54_{T} are generated.

Analogously to the trouble-free operation of the driver and safety device 36, the measurement receive variables 54_{M} and the test receive variables 54_{T} are transmitted to the control and evaluation device 38. The control and evaluation device 38 is used to determine the amplitude image 66 that characterizes the intensity characteristic of the echo signal 60 along the receiving regions 56 of the receiver 52. FIG. 7 shows, analogously to FIG. 5, the section of the amplitude image 66 along a column perpendicular to the rows 58 of the receiver 52, the driver and safety device 36 not functioning correctly in this case.

As shown in FIG. 6, the malfunction means that the trigger output signal 46 is continued after the end of the transmission time interval TS and the laser 40 is still activated to transmit the laser signal 42. The latter portion of the echo signal 60 of the continued laser signal 42 is no longer received using the measurement receiving regions 56_{M} after the end of the measurement time interval TE_{M}. However, the latter portion of the echo signal 60 is received using the test receiving regions 56_{T} until the end of the test time interval TE_{T}. As a result, the test receiving regions 56_{T} are exposed to the laser signal 42 for much longer than the measurement receiving regions 56_{M}. The measurement receive variables 54_{M} of the measurement receiving regions 56_{M} are, as shown in FIG. 7, significantly smaller, compared with trouble-free operation, as shown in FIG. 5, than the test receive variables 54_{T} of the respective adjacent test receiving regions 56_{T}.

The adjacent test receive variables 54_{T} and measurement receive variables 54_{M} are compared with each other. Since the intensity differences between the measurement receive variables 54_{M} and the test receive variables 54_{T} of the adjacent measurement receiving regions 56_{M} and test receiving regions 56_{T} are outside of the specified tolerance limit, a malfunction in the safety means 47 is assumed. The safety shutdown test means 62 is used to generate a fault state in the form of an interruption to the connection between the control connection 44 and the signal connection 48 of the driver and safety device 36.

1. A method for operating an optical detection device provided for monitoring at least one monitoring region,
the method comprising:
actuating at least one light-emitting element to transmit at least one light signal;
receiving at least one reflected light signal using at least two receiving regions of at least one receiver; and
using at least one received light signal to determine at least one receive variable,
wherein a functional safety of the detection device is checked at least intermittently,
wherein a duration of the transmission of each of the light signals is limited to a specified transmission time interval in order to achieve eye safety for the detection device,
wherein the eye safety of the detection device is checked by:
configuring at least one of the receiving regions as a measurement receiving region and at least one of the receiving regions as a test receiving region,
generating at least one measurement receive variable that characterizes a quantity of light captured using at least one measurement receiving region in at least one measurement time interval, and
generating at least one test receive variable that characterizes a quantity of light captured using at least one test receiving region in at least one test time interval,
wherein the at least one test time interval is longer than the at least one measurement time interval and the at least one test time interval being longer than the transmission time interval,
wherein if at least one test receive variable characterizes a quantity of light that is greater, outside of a specified tolerance variable, than the quantity of light that is characterized using the at least one measurement receive variable, a fault state is generated.

2. The method as claimed in claim 1,
wherein at least one measurement time interval, at least one test time interval, and a transmission time interval are realized so as to at least partially overlap in time, and
wherein at least one measurement time interval, at least one test time interval, and a transmission time interval are started simultaneously.

3. The method as claimed in claim 1,
further comprising:
determining at least one test receive variable and at least one measurement receive variable of spatially adjacent receiving regions,
determining respective measurement receive variables of at least two spatially adjacent measurement receiving regions, and
determining respective test receive variables of at least two spatially adjacent test receiving regions.

4. The method as claimed in claim 1,
wherein the at least one measurement time interval is specified as having approximately the same length as the transmission time interval, or
wherein the at least one measurement time interval is specified as not having a greater length than at least one transmission time interval.

5. The method as claimed in claim 1,
wherein at least one check on eye safety is carried out during regular operation of the detection device, or
at least one check on eye safety is carried out outside of regular operation of the detection device.

6. The method as claimed in claim 1,
wherein at least one light-emitting element is used to transmit modulated light signals.

7. The method as claimed in claim 1,
wherein the fault state generated comprises a shutdown of:
at least one light-electric element,
at least one error signal, and
at least one visual, audible and/or haptic output signal.

8. An optical detection device for monitoring at least one monitoring region, the device comprising:
at least one light-emitting element for transmitting light signals;
at least two receiving regions for receiving reflected light signals;
at least one receiver for determining receive variables from received light signals;
at least one evaluating device for controlling the optical detection device and for processing receive variables; and
at least one checking device for checking a functional safety of the detection device,
wherein the detection device comprises at least one safety means for limiting the duration of the transmission of light signals to a specified transmission time interval in order to achieve eye safety and at least one evaluating or checking device for the at least one safety means,
the evaluating or checking device comprising:
means for configuring at least one receiving region as a measurement receiving region for the purpose of generating from at least one received light signal at least one measurement receive variable that characterizes a quantity of light that can be captured using at least one measurement receiving region in at least one measurement time interval,
means for configuring at least one receiving region as a test receiving region for the purpose of generating from at least one received light signal at least one test receive variable that characterizes a quantity of light that can be captured using at least one test receiving region in at least one test time interval,
means for evaluating at least some of the receive variables, and
means for generating at least one fault state if at least one test receive variable characterizes a quantity of light that is greater, outside of a tolerance variable, than the quantity of light that is characterized using at least one measurement receive variable.

9. The detection device as claimed in claim 8,
wherein at least one measurement receiving region and at least one test receiving region are formed from receiving regions of the same type, and
at least one measurement receiving region and at least one test receiving region are configurable separately to record receive variables in different time intervals.

10. The detection device as claimed in claim 9,
wherein at least one receiver comprises multiple point sensors, at least one line sensor and at least one area sensor, which are used to produce respective receiving regions.

11. A vehicle comprising:
at least one detection device for monitoring at least one monitoring region, the at least one detection device comprising:
at least one light-emitting element for transmitting light signals,
at least two receiving regions for receiving reflected light signals,
at least one receiver for determining receive variables from received light signals,
at least one evaluating device for controlling the optical detection device and for processing receive variables, and
at least one checking device for checking a functional safety of the detection device,
wherein the detection device comprises at least one safety means for limiting the duration of the transmission of light signals to a specified transmission time interval in order to achieve eye safety and at least one evaluating or checking device for the at least one safety means,
the evaluating or checking device comprising:
means for configuring at least one receiving region as a measurement receiving region for the purpose of generating from at least one received light signal at least one measurement receive variable that characterizes a quantity of light that can be captured using at least one measurement receiving region in at least one measurement time interval,
means for configuring at least one receiving region as a test receiving region for the purpose of generating from at least one received light signal at least one test receive variable that characterizes a quantity of light that can be captured using at least one test receiving region in at least one test time interval,
means for evaluating at least some of the receive variables, and
means for generating at least one fault state if at least one test receive variable characterizes a quantity of light that is greater, outside of a tolerance variable, than the quantity of light that is characterized using at least one measurement receive variable.

12. The vehicle as claimed in claim 11,
wherein the vehicle comprises at least one driver assistance system.
